(19) United States
(12) Patent Application Publication
(10) Pub. No.: US 2025/0222637 A1
(43) Pub. Date: Jul. 10, 2025

(54) INJECTION MOLDING DEVICE WITH ROTATABLE CORE SECTIONS

(71) Applicant: FOBOHA (Germany) GmbH, Haslach (DE)

(72) Inventor: Rainer Armbruster, Wolfach (DE)

(21) Appl. No.: 18/684,389

(22) PCT Filed: Aug. 22, 2022
(86) PCT No.: PCT/EP2022/073298

§ 371 Date: Feb. 16, 2024

(30) Foreign Application Priority Data
Aug. 20, 2021 (DE) 10 2021 121 679.6

(51) Int. Cl. B29C 45/16; B29C 45/26; B29C 45/36

(52) U.S. Cl. CPC B29C 45/1635; B29C 45/2681; B29C 45/36; B29C 2045/1637; B29C 2045/363

(57) ABSTRACT

An injection molding device for manufacturing of multi-component plastic parts includes at least one first material component and at least one second material component. The injection molding device comprising a transfer means being designed to in the open position of the injection molding device transfer first injection molded material components from at least one group of first cavities into the at least one group of second cavities by rotation.

### FIELD OF THE DISCLOSURE

The present disclosure relates to an injection molding device and a method for injection molding of multi-component plastic parts made from injection molded plastic material.

### BACKGROUND OF THE DISCLOSURE

US2005140053, first published in June 2005 on behalf of Mold Masters Ltd., is directed to an apparatus and a method for injection molding of molded products. It includes a first cavity chamber for forming a seal liner, with the first cavity chamber having an outer edge, and a second cavity chamber for forming a shell, with the second cavity chamber having a center and being adjacent to the first cavity chamber. The injection molding apparatus and method also includes a first nozzle for a seal liner material positioned near the outer edge of, and in communication with, the first cavity chamber, and a second nozzle for a shell material positioned near the center of, and in communication with, the second cavity chamber. The injection molding apparatus and method further includes a mold core capable of being positioned in and moved between the first and second cavity chambers.

WO2007096309A1, first published in August 2007 on behalf of the same applicant, is directed, to an injection molding device for the efficient making of a product comprising at least two material or color components. A device according to the invention in general comprises a first stationary mold half and a second movable mold half. A holding frame is arranged between the first and the second mold half and comprising an in mold transfer system to transfer parts from first into second cavities.

US2013193613, first published in September 2014 on behalf of Tech Mold Inc., is directed to an injection molding device assembly for manufacturing multiple-component articles. It includes opposed first and second mold halves and mold cores carried by the first mold half. Each of the mold cores is mounted for rotation between a first position and a second position about an axis of rotation. The mold halves are mounted for movement in reciprocal directions along an axis of reciprocation between an open position and a closed position forming molding cavities between the mold cores and the second mold halves. The axes of rotation of the mold cores are different from one another.

CN112092279, first published in January 2020 on behalf of Shenzen 3K Mold Co. Ltd., is directed to a double-color die rotating core and a double-color die. The double-color die rotating core comprises a rotating ejector rod capable of being connected with a rotating die core and a rotating assembly for driving the rotating ejector rod to rotate. The rotating assembly is connected with the rotating ejector rod. The rotating assembly comprises a power part, a transmission part and a driving part. The driving part is slidably arranged on the outer wall of the rotary ejector rod in a sleeving manner. The rotary ejector rod and the driving part rotate synchronously. The power part is connected with the driving piece through the transmission piece.

### SUMMARY OF THE DISCLOSURE

The devices known from the prior art are often not efficient for the production of relatively small multi-component plastic parts made from at least one first and at least one second material component by injection molding. The efficiency becomes even worse, when those parts comprise a hollow section or have a tubular design which is encompassed at least partially by two material components as the handling is usually very difficult.

An injection molding device and a process according to the disclosure offer the opportunity to produce parts as mentioned above in a highly efficient manner with respect to cycle time and necessary floor space.

The injection molding device according to the disclosure usually comprises a first mold half and a second mold half during production arranged movable relative to each other in an injection molding machine in a first direction between an open position and a closed position. The first mold half is usually attached to a movable mold clamping plate of the injection molding machine while the second mold half is usually attached to a stationary mold clamping plate of the injection molding machine by which injection of molten plastic material takes place. Depending on the field of application, other arrangements are possible.

During production, the first and the second mold half interact with each other in the closed position along a first side face of the first mold half and a thereto opposite second side face of the second mold half. They are designed to form at least one group of first cavities and at least one thereto laterally offset group of second cavities there between. Per group of first and second cavities at least one transfer means is arranged preferably at the first mold half. The transfer means preferably comprises a base being in the closed position arranged between and at least partially encompassed by the first side face and the second side face, which are correspondingly shaped. The base can act as a spacer between the first and the second mold half. The base is in the open position of the injection molding device arranged rotatable around a rotation axis. The rotation axis is usually arranged parallel to the first direction. The base is usually arranged translatable to a certain extend parallel to the rotation axis to set free for rotation as described in more detail hereinafter. The at least one transfer means is designed to—at least in the open position of the injection molding device—transfer after sufficient curing first injection molded material components from the at least one group of first cavities into the at least one group of second cavities by rotation about the rotation axis. The second group of cavities is usually designed to receive the parts made by injection molding in the first group of cavities. Therefore, each first cavity has a thereto related corresponding second cavity suitable to receive by the transfer means the part made in the respective first cavity. Especially in the case of production of partially hollow and/or tubular parts, special elements, respectively areas of the transfer means may in the closed position of the injection molding device form part (of the group) of the first cavities and/or the second cavities in that they remain in the cavity, respectively protrude into one or several cavities. Depending on the parts to be produced, the first group, respectively the thereto corresponding second group of cavities may comprise each only one cavity instead of several. Furthermore, the group of first cavities and/or the group of second cavities may vary with respect to each other. Each group may comprise different cavities. In a preferred variation, the transfer means is arranged displaceable in the first direction. Thereby it becomes possible to arrange them in a more space saving manner, e.g. laterally closer together. In combination with the sequential turning as mentioned in more detail hereinafter, the efficiency of the injection molding device can be further increased. If appropriate, the transfer means may comprise a base and at least one slide arranged thereat movable with respect to the base between an open and a closed position. The open position usually offers to demold the produced parts while in the closed position the respective cavity is foreseen to receive molten plastic material in an injection molding process. Good results are achieved, when two slides are arranged opposite to each other moving in opposite direction by the same or different distances linearly or along a predefined path between an open and a closed position. Each slide usually comprises at least per first cavity at least one core segment arranged movable with respect to the base. The core segments during production, i.e. in the closed position, usually form part of the one or several first cavities. They can be used to more easily demold at least one hollow section or the inside of the multi-component plastic part after completion of the respective injection molding process.

Depending on the field of application, the base may be designed to comprise at least one throughout opening extending in the first direction. In the closed position during operation, at least one group of first cavities and/or at least one group of second cavities may be arranged at least partially in the throughout opening interacting with each other (the other cavity halves) across the throughout opening. Good results can be achieved, when the at least one slide is during opening and/or closing actuated by a control surface. An efficient design can be achieved, when at least one control surface is arranged at a control finger. In a preferred variation, the control finger protrudes from the first mold half essentially in the direction of the second mold half. The control surface arranged thereon preferably comprises an essentially straight section, which then is followed by a bend section; however, other shapes are thinkable as well. The control surface is designed to displace by interaction with the slide, the slide between the open and the closed position in a controlled manner. The control surface interacts with the respective slide by an interaction surface arranged at the slide or interconnected thereto. Depending on the field of application, instead of control fingers, other kind of actuators would be possible. However, the at least one control finger, as described hereinafter in more detail, offers the possibility to use the relative movement between the first mold half and the base to actuate the movement of the at least one slide relative to its base. Alternatively or in addition, it is possible to actuate the slides in that the thereto related control fingers are arranged moveable with respect to the first mold half. Therefore, the first mold half may comprise a separate actuator to displace the control finger and thereby actuate the slide with respect to the first mold half. If appropriate, the movement of the control finger can be interconnected by a coupling means to the relative movement between the first and the second mold half. The at least one control finger may be arranged at least partially in the first mold half and/or the second mold half. The at least one control finger, respectively the control surface may be arranged adjustable. For the production of higher volumes, the in injection molding device may comprise several rows and/or columns of groups of first and second cavities, each group of cavities comprising a transfer means. As mentioned above, the transfer means of two neighboring columns and/or rows can be arranged turnable in sequence when the injection molding device is in the open position. Therefore, the bases of each transfer means can be displaced in the first direction before turning.

For a space saving design the base preferably comprises a at least in sections curved side wall for reducing the space required by the base perpendicular to the axis of rotation during rotation about the axis of rotation. By avoiding a rectangular design, in case of multiple transfer means, the distance there between can be minimized while neighboring bases are still turnable simultaneously without collision.

A method for the production of injection molded multi-component plastic parts according to the disclosure usually comprises the following method steps: Providing an injection molding device as described herein above and after. In the closed position of the injection molding device injecting a first material component into the group of first cavities. After sufficient curing of the first material component, opening the injection molding device by relative movement of the first mold half with respect to the second mold half in the first direction. Removing the semi-finished products consisting of the first material component by the transfer means from the group of first cavities—if appropriate—by linear moving the transfer means in the first direction in the direction of the second mold half such that the semi-finished products are arranged above the group of first cavities. Transferring the semi-finished products temporarily attached at the transfer means by rotation of the transfer means around a rotation axis arranged parallel to the first direction into a position above the group of second cavities. Inserting the semi-finished products consisting of the first material component into the group of second cavities—if appropriate—by linear moving the transfer means in the first direction in the direction of the first mold half. Closing the injection molding device by relative movement of the first mold half in the first direction in the direction of the second mold half until the semifinished products are encompassed by the group of second cavities. Injecting the second material component into the group of second cavities onto the first material component of the semi-finished product. Opening the injection molding device and releasing the finished products from the transfer means. Especially when the products to be made are hollow, or comprise an undercut, good results can be achieved, when the finished products are demolded by opening at least one slide arranged at the transfer means. Preferably the at least one slide is actuated by a control surface arranged at a control finger. For good results, at least two independently actuatable slides are arranged at the base, such that during demolding the slide temporarily positioned at the second cavities is displaced from the closed into the open position to release the finished parts.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE DRAWINGS

The herein described disclosure will be more fully understood from the detailed description given herein below and the accompanying drawings which should not be considered limiting to the disclosure described in the appended claims. The drawings are showing:

FIG. 1 a variation of an injection molding device in a perspective view from the front and above;

FIG. 2 the injection molding device according to FIG. 1 in a perspective view from the rear and above;

FIG. 3 the inside of a first mold half of the injection molding device according to FIG. 1 in a perspective view from the front and above;

FIG. 4 the inside according to FIG. 3 in a perspective view from behind and above;

FIG. 5 a transfer means of the inside of a first mold half of the injection molding device according to FIG. 1 in a perspective view from the front and above;

FIG. 6 the transfer means according to FIG. 5 in a perspective view from behind and above.

### DESCRIPTION OF THE EMBODIMENTS

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

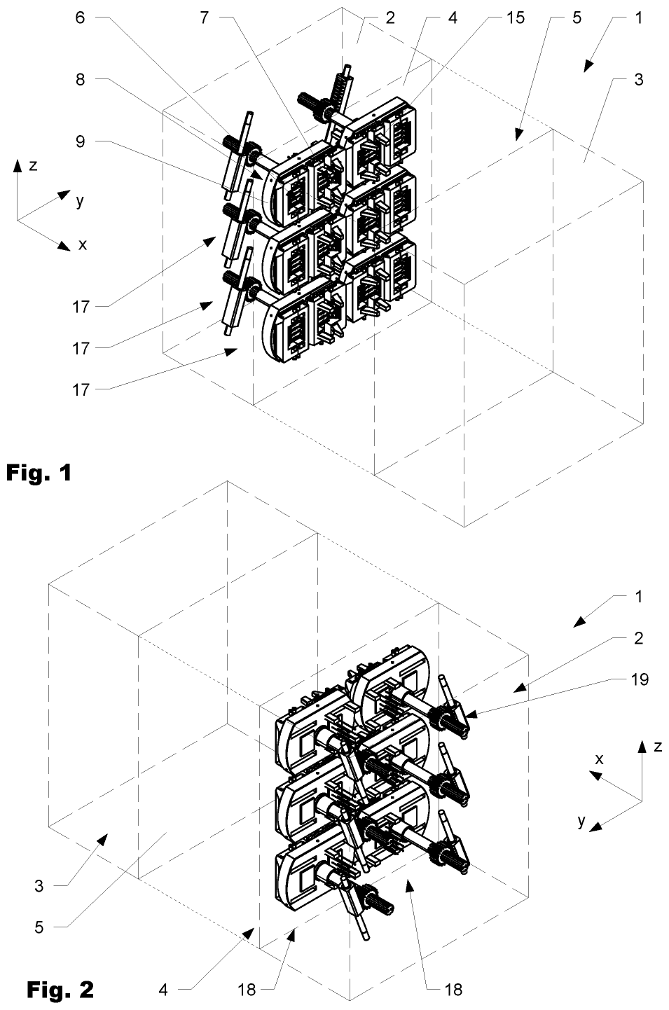

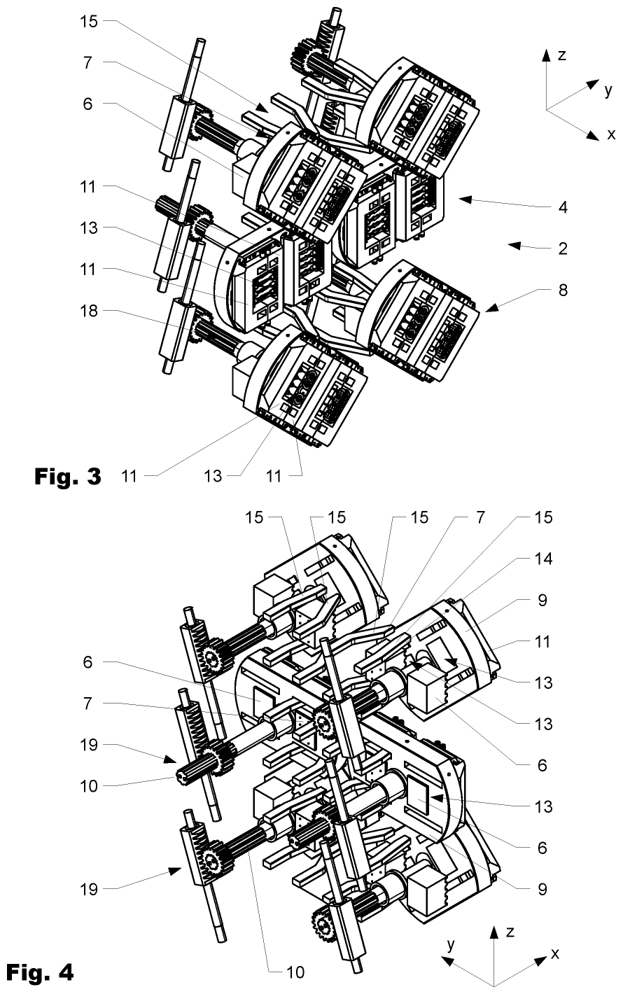

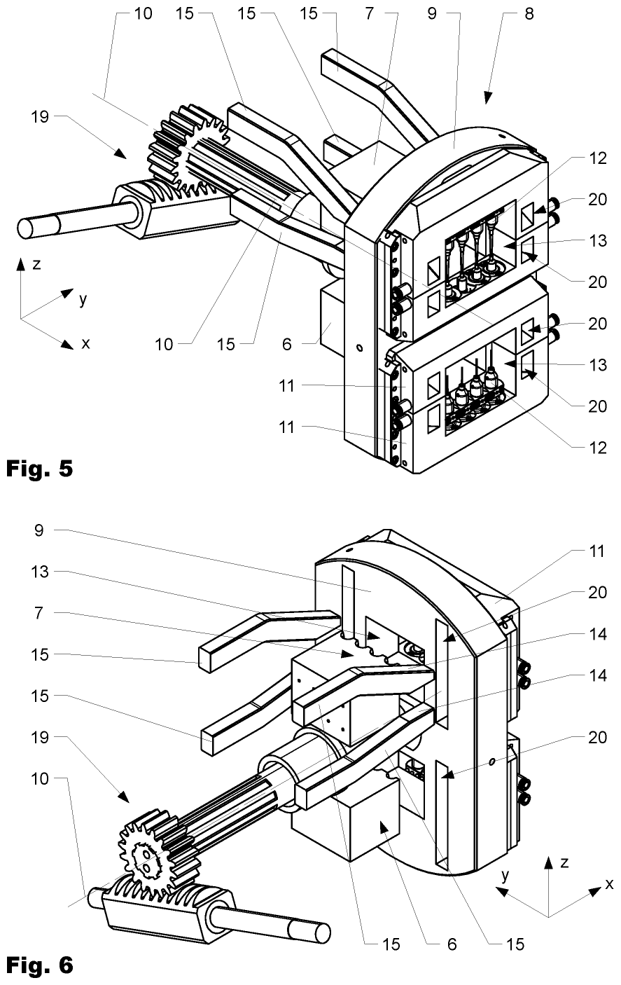

FIG. 1 shows a variation of an injection molding device 1 in a perspective view from the front and above. FIG. 2 shows the injection molding device 1 according to FIG. 1 in a perspective view from the rear and above. FIG. 3 shows the inside of a first mold half 2 of the injection molding device 1 according to FIG. 1 in an isolated manner in a perspective view from the front and above. FIG. 4 shows the inside according to FIG. 3 in a perspective view from behind and above. In FIG. 5 a transfer means 8 is shown in a close-up view as arranged in a first mold half 2 of the injection molding device 1 according to FIG. 1. FIG. 6 shows the transfer means according to FIG. 5 in a perspective view from behind and above.

The injection molding device 1 as shown here in a schematic and simplified manner is suitable for the manufacturing of complex multi-component plastic parts (not shown) comprising at least one first material component and at least one second material component. The injection molding device 1 comprises a first mold half 2 and a second mold half 3 during operation arranged movable relative to each other in a first direction x between an open position and a closed position. In FIGS. 1 and 2 the open position is schematically shown. The outer contours of the first and the second mold halves 2, 3 are schematically indicated by dash-lines. The movement apart from each other is indicated by dotted lines extending between the edges of the mold halves.

In the closed position, the first and the second mold half 2, 3 interact with each other along a first side face 4 of the first mold half 2 and a thereto opposite second side face 5 of the second mold half 3 to form at least one group of first cavities 6 and at least one group of second cavities 7 there between (In the shown drawings, only half of the first and the second cavities are shown). For each group, the second half of the first and the second cavities—which are not shown in the drawings—would be arranged in the second side face 5 of the second mold half 3 opposite to the first half. Per group of first and second cavities 6, 7 at least one transfer means 8 is arranged at the first mold half 2. As best visible in FIGS. 5 and 6, the transfer means 8 comprises a base 9 being in the closed position arranged between and at least partially encompassed by the first side face 4 and the second side face 5 of the first and the second mold halves 2, 3. In the open position as shown, it is arranged rotatable around a rotation axis 10 arranged parallel to the first direction x. The at least one transfer means 8 is designed to in the open position of the injection molding device 1 transfer first injection molded material components (semi-finished products) formed in the first cavities 6 from the at least one group of first cavities 6 into the at least one group of second cavities 7 by rotation about the rotation axis 10. In the shown variation, the transfer means 8 forms in the closed position of the injection molding device 1 part of the group of first cavities 6 and/or the group of second cavities 7 in that in at least one of the cavities it gets in contact with plastic material during injection. In a space saving arrangement as in the shown variation, the transfer means 8 are arranged displaceable in the first direction x. This allows space saving rotation of the first and the second cavities by sequential rotation.

The transfer means 8 as shown in an isolated manner in FIG. 5 and FIG. 6, comprises a base 9 and two slides 11 arranged thereon comprising per first cavity 6 a core segment 12 arranged movable with respect to the base 9 e.g. to easily demold at least one hollow section of the multi-component plastic part. The base 9 comprises at least one throughout opening 13 extending in the first direction x and in which in the closed position of the injection molding device 1 at least one group of first cavities 6 and/or at least one group of second cavities 7 are arranged. As visible in FIG. 5 and FIG. 6, the base 9 comprises two throughout openings 13.

In the shown variation, each slide 11 is actuated by a control surfaces 14 arranged at a control fingers 15. The control fingers 15 protrude from the first mold half 2 in the direction of the second mold half 3, as best visible in FIG. 2. The control surface 14 engages during actuation with a corresponding interaction surface of the respective slide 11 arranged at an angle within an opening 20 of the slide 11. By displacing the slides 11, the core segment 12 is retractable from the molded part, which can be demolded by ejector pins, visible on FIG. 2.

In a special design, the control fingers 15 are arranged displaceable relative to the first mold half 2. The first mold half comprises an actuator 19, in particular a rotary actuator 19, to displace the control finger 15 with respect to the first mold half 2. As visible, the control fingers 15 are arranged at least partially in the first mold half 2. The in injection molding device 1 comprises several rows and/or columns 17, 18 of groups of first and second cavities 6, 7 each group of cavities comprising a transfer means 8. In the shown variation, the transfer means 8 of two neighboring columns and/or rows are arranged turnable in sequence when the injection molding device 1 is in the open position. This allows a space saving design, since the transfer means 8 can be arranged closely together, while still being rotatable without colliding with each other. In the shown variation, the bases 9 of each transfer means 8 are displaced in the first direction x before turning. This is due to the bases 9 being in the closed position at least partially recessed in the first mold half 2 and thereby arrested about the axis of rotation.

During production of injection molded multi-component plastic parts in the closed position of the injection molding device 1 a first material component is injected into the group of first cavities 6 in a liquefied manner. After sufficient curing of the first material component, the injection molding device 1 is opened by relative movement of the first mold half 2 with respect to the second mold half 3 in the first direction (x). The semi-finished products consisting of the first material component are removed from the group of first cavities 6 by the transfer means 8 by linear moving the transfer means 8 in the first direction (x) in the direction of the second mold half such that the semi-finished products are arranged above the group of first cavities 6. The semi-finished products which are temporarily attached at the transfer means 8 are transferred by rotation of the transfer means 8 around rotation axis 10 which in the shown variation is arranged essentially parallel to the first direction (x) into a position above the group of second cavities 7. The semi-finished products consisting of the first material component are inserted into the group of second cavities 7 by linear moving the transfer means in the first direction in the direction of the first mold half. The injection molding device is closed by relative movement of the first mold half 2 in the first direction (x) in the direction of the second mold half 3 until the semi-finished products are encompassed in the second cavities 7. Injecting the second material component into the second cavities 7 onto the first material component of the semi-finished product. After curing the injection molding device 1 is opened and the finished products from the transfer means 8. Especially when the products to be made are hollow, or comprise an undercut, good results can be achieved, when the finished products are released by opening at least one slide 11 arranged at the transfer means.

Rather, the words used in the specification are words of description rather than limitation, and it is understood that various changes may be made without departing from the scope of the disclosure.

### LIST OF DESIGNATIONS

1 Injection molding device
2 First mold half
3 Second mold half
4 First side face (first mold half)
5 Second side face (second mold half)
6 First cavities
7 Second cavities
8 Transfer means
9 Base (transfer means)
10 Rotation axis (transfer means)
11 Slide (transfer means)
12 Core segment (cavity)
13 Throughout opening (transfer means)
14 Control surface (slide)
15 Control finger (slide)
17 Row (of groups of cavities)
18 Columns (of group of cavities)
19 Rotary actuator (Transfer means)
20 Openings (for control finger)

1. An injection molding device (1) for manufacturing of multi-component plastic parts comprising at least one first material component and at least one second material component, the injection molding device (1) comprising:
a. a first mold half (2) and a second mold half (3) arranged movable relative to each other in a first direction (x) between an open position and a closed position in which the first and the second mold half (2, 3) interact with each other along a first side face (4) of the first mold half (2) and a thereto opposite second side face (5) of the second mold half (3) to form at least one group of first cavities (6) and at least one group of second cavities (7) there between;
b. per group of first and second cavities (6, 7) at least one transfer means (8) arranged at the first mold half (2) and comprising a base (9) and at least one slide (11) arranged thereon comprising per first cavity (6) at least one core segment (12) arranged movable with respect to the base (9), to demold at least one hollow section of the multi-component plastic part, wherein the base (9) being in the closed position arranged between and at least partially encompassed by the first side face (4) and the second side face (5) and in the open position being arranged rotatable around a rotation axis (10) arranged parallel to the first direction (x), wherein
c. the at least one transfer means (8) being designed to in the open position of the injection molding device (1) transfer first injection molded material components from the at least one group of first cavities (6) into the at least one group of second cavities (7) by rotation about the rotation axis.

2. The injection molding device (1) according to claim 1, wherein the transfer means (8) in the closed position of the injection molding device (1) forms part of the group of first cavities (6) and/or the group of second cavities (7).

3. The injection molding device (1) according to any of the preceding claims, wherein the transfer means (8) is arranged displaceable in the first direction (x).

4. canceled

5. The injection molding device (1) according to claim 1, wherein the base (9) comprises at least one throughout opening (13) extending in the first direction (x) and in which in the closed position at least one group of first cavities and/or at least one group of second cavities (6, 7) are arranged.

6. he injection molding device (1) according to claim 1, wherein the at least one slide (11) is actuated by a control surface (14) arranged at a control finger (15).

7. The injection molding device (1) according to claim 6, wherein the control finger (15) protrudes from the first mold half (2) in the direction of the second mold half (3).

8. The injection molding device (1) according to claim 6 or claim 7, wherein the control finger (15) is arranged displaceable relative to the first mold half (2).

9. The injection molding device (1) according to claim 6, wherein the first mold half comprises an actuator to displace the control finger (15) with respect to the first mold half (2).

10. The injection molding device (1) according to claim 6, wherein the control finger (15) is arranged at least partially in the first mold half (2).

11. The injection molding device (1) according to claim 1, wherein the in injection molding device (1) comprises several rows and/or columns (17, 18) of groups of first and second cavities (6, 7) each group of cavities comprising a transfer means (8).

12. The injection molding device (1) according to claim 6, wherein the transfer means (8) of two neighboring columns and/or rows are arranged turnable in sequence when the injection molding device (1) is in the open position.

13. The injection molding device (1) according to claim 12, wherein the bases (9) of each transfer means (8) are displaced in the first direction (x) before turning.

14. The injection molding device (1) according to claim 1, wherein the at least one group of first cavities (6) and the at least one group of second cavities (7) each comprise only one cavity.

15. Method for the production of injection molded multi-component plastic parts comprising at least one first material component and at least one second material component comprising the following method steps:
a. providing an injection molding device (1) according to anyone of the preceding claims;
b. in the closed position of the injection molding device (1) injecting a first material component into a group of first cavities (6);
c. after sufficient curing of the first material component, opening the injection molding device (1) by relative movement of the first mold half (2) with respect to the second mold half (3) in a first direction (x);
d. removing semi-finished products consisting of the first material component by the transfer means (8) from the group of first cavities (6) by linear moving the transfer means (8) in the first direction (x) in the direction of the second mold half (3) such that the semi-finished products are arranged above the group of first cavities (6);
e. transferring the first material components temporarily attached at the transfer means (8) by rotation of the transfer means (8) around a rotation axis (10) arranged parallel to the first direction (x) into a position in front of second cavities (7);
f. inserting the first material components into the group of second cavities (7) by linear moving the transfer means (8) in the first direction (x) in the direction of the first mold half (2);
g. closing the injection molding device (1) by relative movement of the first mold half (2) in the first direction (x) in the direction of the second mold half (3) until the first material components are encompassed by the group of second cavities (7);
h. injecting the second material component into the group of second cavities (7) onto the first material component of the semi-finished product;
i. opening the injection molding device (1) and demolding the finished products from the transfer means (8).

16. Method according to claim 15, wherein the finished products are demolded by opening at least one slide (11) arranged at the transfer means (8).
